(19) United States
(12) Patent Application Publication
(10) Pub. No.: US 2018/0043208 A1
(43) Pub. Date: Feb. 15, 2018

(54) Treadmill with Guides that Assist in Performing Physical Therapy

(71) Applicant: James W. Foster, Levittown, PA (US)

(72) Inventor: James W. Foster, Levittown, PA (US)

(21) Appl. No.: 15/673,396

(22) Filed: Aug. 9, 2017

Related U.S. Application Data
(60) Provisional application No. 62/372,781, filed on Aug. 9, 2016.

(51) Int. Cl. A63B 22/02; A63B 24/00; G09B 19/00; A63B 71/06; A63B 71/00

(52) U.S. Cl. CPC A63B 22/0235; A63B 71/0622; A63B 71/0054; G09B 19/0038; A63B 24/0062; A63B 2071/0655; A63B 2225/09; A63B 2220/806; A63B 2220/833; A63B 2220/56

(57) ABSTRACT

A rehabilitation system used to assist a person improve walking skills while walking on a treadmill. A treadmill is provided that has a moving belt track. A framework is provided having frame elements that extend over the belt track of the treadmill. Foot guide rails are suspended from the frame elements that extend over the belt track of the treadmill. The foot guide rails define two foot channels above the belt track that guide a user's feet when they walk on the treadmill. Guide pads are supported by the framework. The guide pads inhibit a user from falling while walking on the treadmill. The guide pads also can be adjusted to provide tactile indications of when a person is walking in an abnormal manner.

### RELATED APPLICATIONS

This application claims priority of U.S. Provisional Application No. 62/372,781 filed Aug. 9, 2016.

### BACKGROUND OF THE INVENTION

### 1. Field of the Invention

In general, the present invention relates to guides that attach to, or are part of, a treadmill. More particularly, the present invention relates to guides that support the user's body and/or help orient the user's body and feet as they advance along a treadmill.

### 2. Prior Art Description

People suffer from a variety of ailments that affect their ability to walk. Many of those ailments, such as brain injury or stroke, have accompanying neurological damage that require a person to relearn the muscle response sequence required to walk properly.

One of the common problems in rehabilitating a person with neurological damage is to teach that person proper foot placement and how to maintain a balanced body posture as they walk. If a person can learn proper foot placement, and can walk with a balanced posture, then that person is stable and is not at increased risk of falling and becoming further injured. Once a person can walk with a balanced posture and proper foot placement, there is a good chance that the person can fully recover and can walk with a balanced gait and no significant limp.

When a person walks, he/she seldom walks a constant pace. Rather, people naturally speed up, slow down and pause to rest. When a person travels to a rehabilitation facility, much of the rehabilitation needed to reteach walking is performed on a treadmill. Treadmills are machines that require a person to walk at the constant pace set on the treadmill. However, due to the constant movement of the treadmill's track, it is very easy to fall on a treadmill. If a person hesitates and fails to keep pace with the treadmill, falling is nearly inevitable. Furthermore, if a person loses his/her balance trying to keep pace with a treadmill, that person may fall. Additionally, in order to walk on a treadmill, a person must have proper foot placement as they walk. This element is lacking in many people who require rehabilitation. It is difficult to teach proper foot placement on a treadmill without a person looking down at his/her feet.

In the prior art, there are safety systems that are intended to help a person walk on a treadmill and reduce the risk of falling. Some prior art systems use pads positioned around a person to prevent them from falling. Such prior art is exemplified by U.S. Pat. No. 4,743,009 to Beale. Although such systems may make walking on a treadmill safer, they do not help a person walk correctly. The padding is for safety only and does nothing to correct deficiencies in posture, shoulder lean, or body sway. Furthermore, such prior art safety systems only provide guides for the body. Such prior art systems provide no guidance whatsoever to the feet.

A need therefore exists for a treadmill based system that helps guide a person's feet as they walk on a treadmill. In this manner, a person can learn to walk properly without having to look at their feet as they walk. A need also exists for a system that prevents a person from falling on a treadmill while providing tactile feedback that can assist a person to improve posture, shoulder lean, and stride sway. These needs are met by the present invention as described and claimed below.

### SUMMARY OF THE INVENTION

The present invention is a rehabilitation system used to assist a person improve walking skills while walking on a treadmill.

A treadmill is provided that has a moving belt track. A framework is provided having frame elements that extend over the belt track of the treadmill. Foot guide rails are suspended from the frame elements that extend over the belt track of the treadmill. The foot guide rails define two foot channels above the belt track that guide a user's feet when they walk on the treadmill.

Guide pads are supported by the framework. The guide pads inhibit a user from falling while walking on the treadmill. The guide pads also can be adjusted to provide tactile indications of when a person is walking in an abnormal manner. The tactile indicators enable a person to instinctively correct their body movements to walk in an improved manner.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of a traditional prior art treadmill;

FIG. 2 is a perspective view of a treadmill system showing the placement of guide pads in accordance with the present invention;

FIG. 3 is a top view of the treadmill platform shown in conjunction with imaginary footsteps;

FIG. 4 is a perspective view of a treadmill system showing the placement of cameras and a display in accordance with the present invention;

FIG. 5 shows an exemplary embodiment of the framework used to support the guide pads of FIG. 2 and the electronics of FIG. 4; and

FIG. 6 is a perspective view of a treadmill system showing the placement of optical sensors in accordance with the present invention.

### DETAILED DESCRIPTION OF THE DRAWINGS

Although the present invention treadmill system can be embodied in many ways, only a few exemplary embodiments are illustrated for the purposes of description and discussion. These embodiments are selected in order to set forth some of the best modes contemplated for the invention. The illustrated embodiments, however, are merely exemplary and should not be considered limitations when interpreting the scope of the claims.

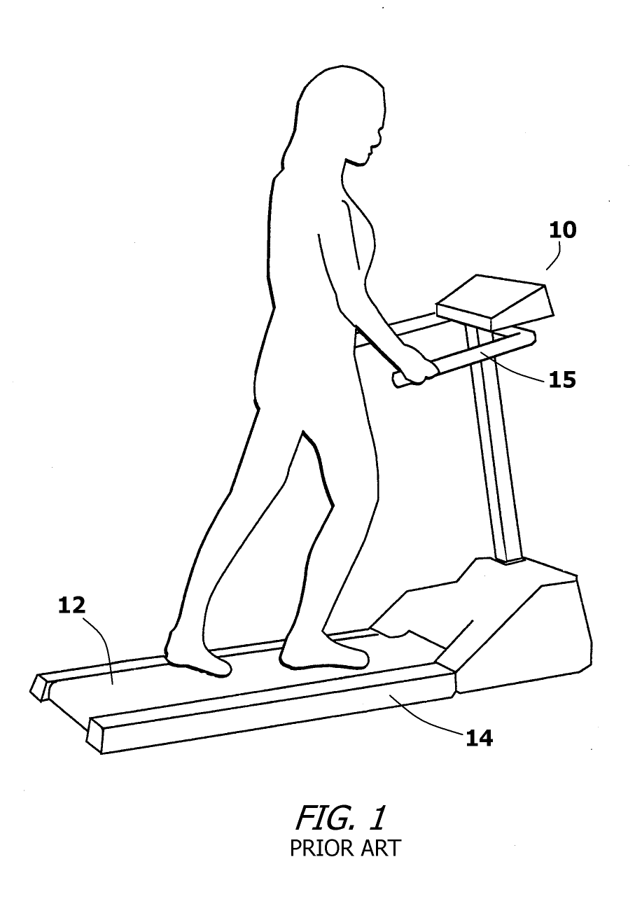

Referring to FIG. 1, a traditional prior art treadmill 10 is shown. The treadmill 10 has a belt track 12 that revolves around a base platform 14. The belt track 12 moves across the top of the base platform 14. A person stands upon the belt track 12 and walks as the belt track 12 rotates. The treadmill illustrated is a tradition land treadmill. However, it should be understood that an underwater treadmill could also be used.

The treadmill 10 has no features that guide the position of the body or the movement of the feet. The only guides provided are the handrails 15. However, the handrails 15 extend along the sides of the treadmill 10 and are designed to be optionally grasped by the hands of the person walking on the treadmill 10.

The present invention system has two primary functions. The first function is to physically prompt a person on a treadmill into walking in an anatomically proper manner. That is, to walk straight with proper posture, no leanings, and no limp. The physical prompting is created using a series of guide pads around the user's body. The second function is to guide a person's feet to ensure the feet are properly positioned for walking after each step.

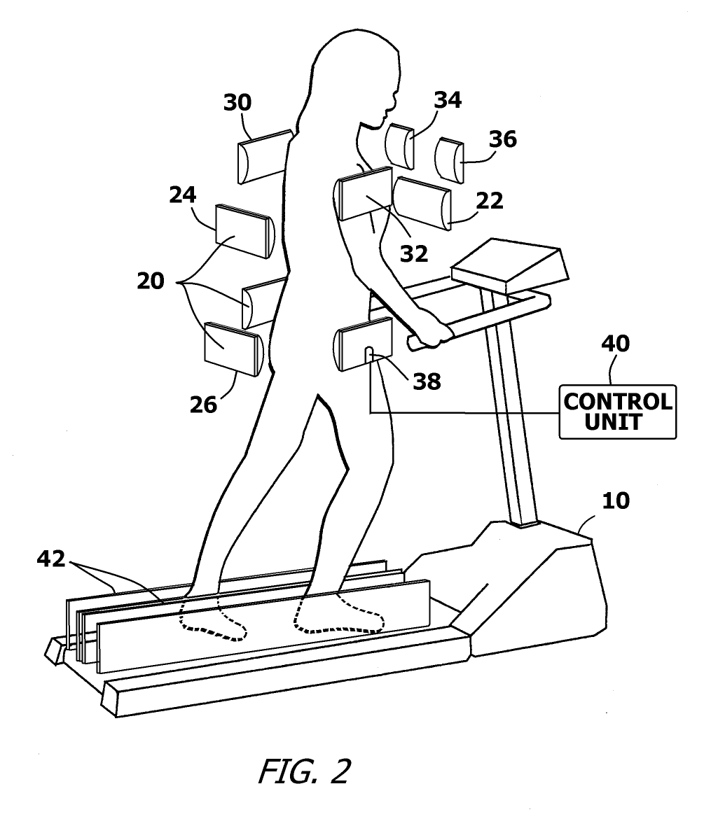

Referring to FIG. 2, it can be seen that the guide pads 20 include a chest pad 22 that is positioned in front of the user's chest as the user walks. The chest pad 22 works in conjunction with a back pad 24 and a gluteus pad 26. The back pad 24 is positioned behind the back of the person on the treadmill 10. The gluteus pad 26 is positioned behind the gluteus muscles. The chest pad 22 prevents the user from falling forward while walking on the treadmill 10. The back pad 24 prevents the user from falling backward while walking on the treadmill 10. The chest pad 22 and the gluteus pad 26 work together to prevent the user from bending at the waist and collapsing while walking on the treadmill 10.

Two hip pads 28, 29 are provided, wherein one of the hip pads 28, 29 is positioned on either side of the user at hip height. The hip pads 28, 29 prevent the user from falling to either side as the user walks on the treadmill 10. The hip pads 28, 29 work in conjunction with a set of two lateral pads 30, 32. The lateral pads 30, 32 are positioned on the outside of the user's upper arms. The presence of the lateral pads 30, 32 prevents the user from falling to either side. The lateral pads 30, 32 also prevent the user from swaying from side to side beyond a normal range while walking on the treadmill 10.

Shoulder pads 34, 36 may also be provided that are positioned in front of the user's shoulders. The shoulder pads 34, 36 prevent the user from leaning forward with either shoulder when walking on the treadmill 10. This helps keep the shoulders in a common vertical plane, therein promoting proper posture and balance.

All of the guide pads 20 shown in FIG. 2 can be adjusted both vertically and laterally to meet the anatomical needs of the person using the treadmill. As a person walks, that person's body naturally moves up and down, back and forth and side to side within a normal range of movement. The various guide pads 20 are adjusted in position to be just beyond the normal range of movement. In this manner, if a user has a body movement that is abnormal for that user, the guide pads 20 will be touched by the body and will provide a tactile indication to the user. The user can then attempt to adjust his/her gait in a manner that prevents contact with the guide pads.

Additionally, any or all of the guide pads can be set to the requirements of a physical therapist. For example, if a person has an injury that causes them to lean to the left, the left lateral pad 32 can be positioned close to the user's body. As the person walks, they will feel the lateral pad 32 touching their leaning shoulder. The user can then attempt to walk straighter without touching the lateral pad 32. This correction will eventually become part of the user's muscle memory and the lean to the left can be eliminated or otherwise reduced. As a second example, imagine a person's malady causes that person to walk with one shoulder leaning farther forward than the other. In such a circumstance, the shoulder pads 34, 36 can be adjusted so that one lightly touches the forward leaning shoulder as the user walks. This provides tactile feedback. That user can then attempt to walk straighter without touching the shoulder pads 34, 36. This correction will eventually become part of the user's muscle memory and the forward shoulder lean can be eliminated or otherwise reduced.

The various guide pads 20 can be normal inert pads. However, in the preferred embodiment, each of the guide pads 20 contains pressure sensors 38 that can detect if the guide pads 20 are being contacted, how often the guide pads 20 are being contacted and with what force the guide pads 20 are being contacted. The contact information detected by the pressure sensors 38 is read by a control unit 40 that can prepare a report. The report can be used to adjust the system and or perform other corrective measures to help the user in his/her physical therapy.

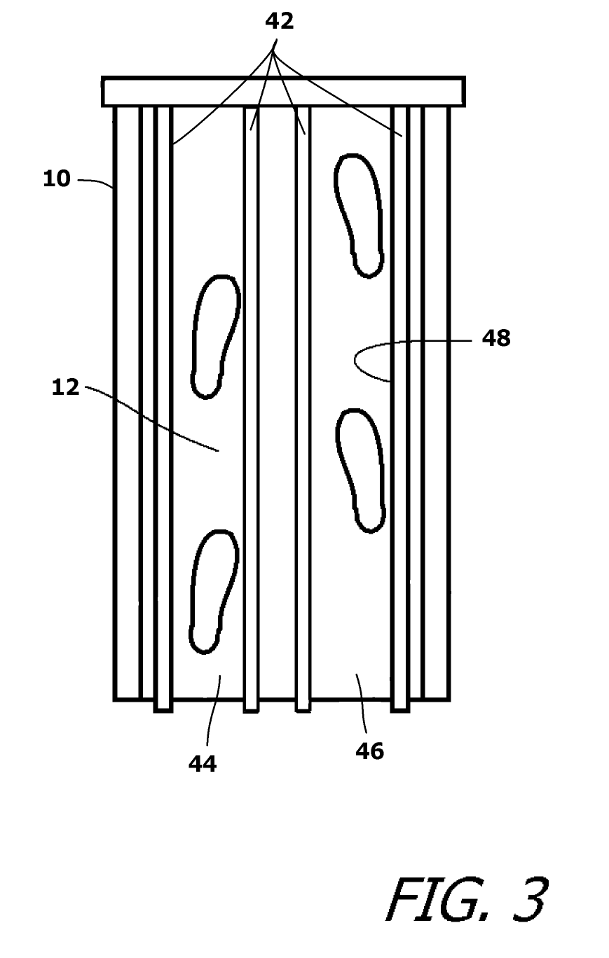

In addition to the guide pads 20 around the body, guides for the feet are also provided. Referring to FIG. 2 in conjunction with FIG. 3, it will be understood that the guides for the feet come in the form of foot guide rails 42. The foot guide rails 42 are held suspended above the belt track 12 so they do not interfere with the free rotation of the belt track 12. The foot guide rails 42 create two parallel channels 44, 46 just above the belt track 12 of the treadmill 10. The two channels 44, 46 are independently adjustable in width and are set to be just wider than the naturally occurring pronation of the user's foot. Accordingly, the width of the channels 44, 46 can be adjusted to the needs of an individual. The foot guide rails 42 preferably run the length of the belt track 12. However, the foot guide rails 42 may be slightly shorter than the belt track 12 depending upon the make and model of the treadmill 10.

In FIG. 3, it can be seen that each of the foot guide rails 42 has a flat inside surface 48 that faces toward one of the foot channels. The inside surface 48 is smooth and may be polished or coated in a non-stick material. In this manner, contact with a foot rail will not prevent a foot from moving forward when walking. The inside surface 48 has a height of between three inches and twelve inches. The presence of the foot guide rails 42 presents a barrier that prevents the feet of a person walking on the treadmill 10 from leaving either of the foot channels 44, 46.

If a person is walking with a straight even gait, that person's feet will not touch the foot guide rails 42. However, if a person is walking with a gait that turns one or both feet outwardly or inwardly, that foot will strike the closest of the foot guide rails 42. A person walking on the belt track 12 is therefore provided with instant tactile feedback as to whether they are walking with their feet straight. The feedback occurs when the feet touch the foot guide rails 42. As such, the feedback is tactile and occurs while the person is walking normally and looking forward. There is no need to look down at one's own feet during physical therapy.

The width of the foot channels 44, 46 can first be set very wide. As a person's walking abilities improve, the foot guide rails 42 can be set closer together, therein tightening the foot channels 44, 46. The adjustment is made to accompany improvements in walking ability and foot positioning. The adjustments are continued until they fall into the normal range for a person with the body type of the user.

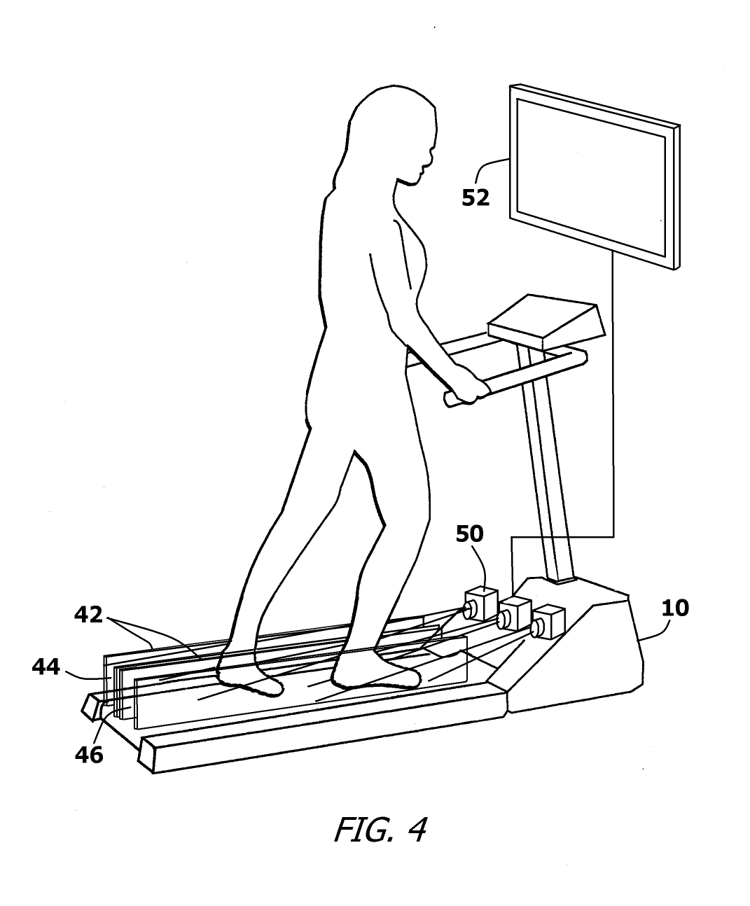

Referring to FIG. 4, it can be seen that in addition to the guide pads 20, the system comes equipped with cameras 50 that image the user's feet as they walk on the treadmill 10. The cameras 50 are joined to a display 52 that is positioned in front of the treadmill 10. In this manner, when the user is walking on the treadmill 10, that person can see the position of his/her feet without looking downward. This enables the user to have confidence in the positioning of his/her feet while looking forward with the proper posture for walking.

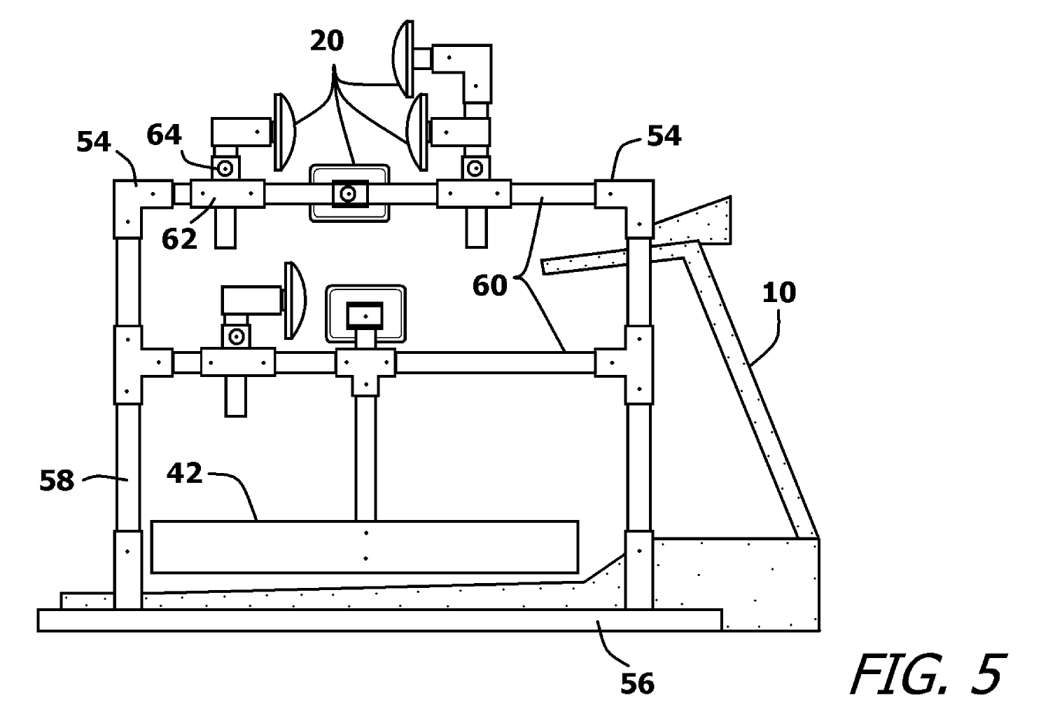

Referring to FIG. 5, in conjunction with FIG. 2, it will be understood that the various guide pads 20 and foot guide rails 42 are supported in place around the treadmill 10 using a framework 54. The framework 54 has floor rails 56 that rest on the floor on either side of the treadmill 10. Vertical frame elements 58 extend vertically from the floor rails 56. Lateral frame elements 60 connect the vertical frame elements 58 around the periphery of the treadmill 10. The floor rails 56, vertical frame elements 58 and/or lateral frame elements 60 can be telescopically adjustable. In this manner, each of the elements in the framework 54 can be adjusted to the dimensions of a particular treadmill 10 and the needs of the user walking on the treadmill 10.

Slide brackets 62 are provided that can slide along the various lateral frame elements 60. The slide brackets 62 have screw knobs 64 or other locking mechanisms that can used to lock the slide brackets 62 in place. Some of the guide pads 20 have a support element 66 that engages one of the slide brackets 62. By adjusting the position of the slide brackets 62 and the position of the support elements 66 in the slide brackets 62, each of the guide pads 20 can be adjusted in position to the needs of a particular user.

Since many of the guide pads 20 have left/right symmetry. Mechanisms, such as pulley systems and/or geared systems can be used that automatically adjust a guide pad 20 on the opposite side of the system when its mirrored guide pad on the near side is manually adjusted. In this manner, it is known that the guide pads 20 on either side of the treadmill 10 are always symmetric, being equal and opposite in position.

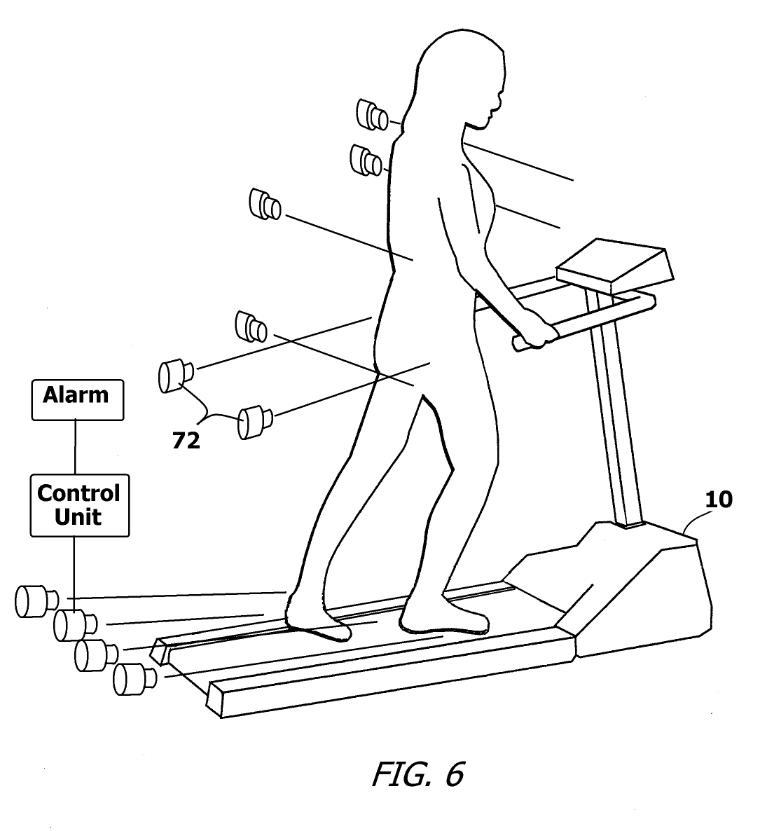

As a user continues rehabilitation, the user may become strong and have little chance of falling when walking. In such a scenario, the guide pads 20 and the foot guide rails 42 can be removed and replaced with passive sensors. Referring to FIG. 6, it can be seen that limits to the movements of the user can be monitored using optical sensors 70, such as lasers and laser light detectors. The optical sensors 70 shine beams along the lines that the user should not pass when walking properly on the treadmill 10. If the user walks incorrectly, the beam is broken and an audible alarm can sound. This provides automatic audio feedback to the user. The breaking of the beam is also recorded digitally. In this manner, the system's administrator can determine what part of the body is out of alignment and appropriate remedial action can be taken.

Returning to FIG. 3, it will be understood that all guide pads 20, cameras 50 and/or optical sensors 70 can be attached to the framework 54. The framework 54 shown is an auxiliary structure that is placed around and over an existing treadmill 10. However, it should be understood that the framework 54 can be constructed as part of a treadmill 10 by a treadmill manufacturer. The framework 54 can be manufactured as part of a treadmill 10 or can be retroactively added to an existing treadmill 10. The framework 54 can also be used to support other features that assist in the rehabilitation of a person with neurological damage. For example, if a person is very prone to falling, a harness can be provided. The harness can be suspended from opposite sides of the framework and can bear all or part of the weight of the person on the treadmill.

It will be understood that the embodiments of the present invention that are illustrated and described are merely exemplary and that a person skilled in the art can make many variations to those embodiments. For example, the shape of the framework will vary depending upon the treadmill being used, the guide pads attached to the framework and the anatomy and needs of the person walking on the treadmill. The framework and treadmill can be adapted for use in a pool. Likewise the framework and treadmill can be used to habilitate animals if walking therapy is required. All such embodiments are intended to be included within the scope of the present invention as defined by the appended claims.

What is claimed is:

1. A rehabilitation system for use with a treadmill, wherein said treadmill has a moving belt track, said system comprising:
foot guide rails suspended over said belt track of said treadmill, wherein said foot guide rails define two foot channels above said belt track.

2. The rehabilitation system according to claim 1, further including a framework that supports said foot guide rails.

3. The rehabilitation system according to claim 2, wherein said framework overlays said treadmill without mounting to said treadmill.

4. The rehabilitation system according to claim 2, wherein said framework is integrated with said treadmill.

5. The rehabilitation system according to claim 1, further including a camera and a display, wherein said camera is directed toward said two foot channels and said display is viewable by a person walking forward on said treadmill.

6. The rehabilitation system according to claim 2, further including guide pads supported by said framework, wherein said guide pads inhibit a person from falling when on said treadmill.

7. The rehabilitation system according to claim 6, wherein at least some of said guide pads are adjustable in position on said framework.

8. The rehabilitation system according to claim 6, wherein said guide pads include a chest guide pad that prevents a person from falling forward when walking on said treadmill.

9. The rehabilitation system according to claim 6, wherein said guide pads include a back guide pad that prevents a person from falling backward when walking on said treadmill.

10. The rehabilitation system according to claim 6, wherein said guide pads include a gluteus pad that prevents a person from excessively bending when walking on said treadmill.

11. The rehabilitation system according to claim 6, wherein said guide pads include hip guide pads that prevent a person from falling to either side when walking on said treadmill.

12. The rehabilitation system according to claim 6, wherein said guide pads include shoulder guide pads that provide a tactile indication if a person walking on said treadmill is leaning forward with either shoulder.

13. A rehabilitation system, comprising:
a treadmill, wherein said treadmill has a moving belt track;
a framework with frame elements that extend over said belt track of said treadmill; and
foot guide rails suspended from said frame elements over said belt track of said treadmill, wherein said foot guide rails define two foot channels above said belt track.

14. The rehabilitation system according to claim 13, further including a camera and a display, wherein said camera is directed toward said two foot channels and said display is viewable by a person walking forward on said treadmill.

15. The rehabilitation system according to claim 13, further including guide pads supported by said frame elements of said framework, wherein said guide pads inhibit a person from falling when on said treadmill.

16. The rehabilitation system according to claim 15, wherein at least some of said guide pads are adjustable in position on said framework.

16. The rehabilitation system according to claim 15, wherein at least some of said guide pads are adjustable in position on said framework.

17. The rehabilitation system according to claim 15, wherein at least some of said guide pads provide tactile input intended to indicate an abnormal walking condition.

18. The rehabilitation system according to claim 13, wherein each of said foot guide rails has a selectively adjustable width.
